(19) United States
(12) Patent Application Publication
(10) Pub. No.: US 2019/0350406 A1
(43) Pub. Date: Nov. 21, 2019

(54) MULTI-FUNCTION GRIDDLE PAN

(71) Applicant: Electrolux Home Products, Inc., Charlotte, NC (US)

(72) Inventors: Steven Swayne, Nashville, TN (US); Catherine L. May, Springfield, TN (US); Desirea Lewis, Clarksville, TN (US); Michael D. Padgett, Springfield, TN (US); Laura Wade, Christiana, TN (US); Andrew Worley, Springfield, TN (US)

(21) Appl. No.: 15/979,533

(22) Filed: May 15, 2018

(51) Int. Cl. A47J 37/06; A23L 5/10

(52) U.S. Cl. CPC A47J 37/067; A23V 2002/00; A23L 5/10

(57) ABSTRACT

A multi-function griddle pan assembly includes a pan and an insert removably positionable thereon. The pan includes a pan surface and a pan sidewall extending from or adjacent a peripheral edge of the pan surface. The insert includes: a planar wall having a top surface, a bottom surface, and a plurality of apertures therein; and an insert sidewall extending from or adjacent a peripheral edge of the top surface. In a first configuration, the insert rests on the pan surface to provide a broiler usable in an oven. In a second configuration the insert rests on the pan surface to provide a charbroiler or grill usable on the cooktop.

### BACKGROUND

### 1. Field of the Invention

The following description relates generally to a multi-function pan assembly that can be used as an oven broil pan or a cooktop griddle.

### 2. Related Art and Background

Food supporting pans can be used to cook food on grills, barbeques, or stovetops. The pans are typically used to help keep the food from falling through cooking grates and/or to protect the food from burning due to direct contact with a flame or heating element.

### BRIEF SUMMARY

The following summary presents a simplified summary in order to provide a basic understanding of some aspects of the devices and systems discussed herein. This summary is not an extensive overview.

In accordance with one aspect, a multi-function griddle pan assembly includes a pan and an insert removably positionable thereon. The pan includes a pan surface and a pan sidewall extending from or adjacent a peripheral edge of the pan surface. The insert includes a planar wall having a top surface, a bottom surface, and a plurality of apertures therein. The insert further includes an insert sidewall extending from or adjacent a peripheral edge of the top surface. In a first configuration the insert sidewall is configured and dimensioned to rest and support the insert on the pan surface inward of or bounded by the pan sidewall such that the planar wall of the insert is spaced above the pan surface a distance corresponding to a height of the insert sidewall. In a second configuration the insert planar wall is configured and dimensioned such that its top surface rests and supports the insert on the pan surface inward of or bounded by the pan sidewall, such that the insert sidewall extends upward from the pan surface.

In accordance with another aspect, a method of cooking utilizing a griddle-pan assembly is disclosed. The assembly includes a pan having a pan surface and a pan sidewall wall extending from the pan surface, and an insert having an apertured planar wall and an insert sidewall extending from a top surface of the planar wall. The method includes the step of configuring the griddle-pan assembly in a broiler configuration by positioning the insert within the pan such that a perimeter edge of the insert sidewall rests on the pan surface, wherein the planar wall of the insert is spaced above the pan surface a distance corresponding to a length of the sidewall. The method further includes the step of configuring the griddle-pan assembly in a charbroiler configuration by inverting the insert such that the top surface of the apertured planar wall thereof rests on the pan surface, wherein the insert sidewalls extend upward away from the pan surface.

### BRIEF DESCRIPTION OF THE DRAWINGS

Embodiments will now be described in further detail with reference to the accompanying drawings, in which:

FIG. 1 shows an example embodiment of a multi-function griddle pan assembly;

FIG. 2 shows an example embodiment of a pan with a flange;

FIG. 3A shows an example embodiment of an unfolded pan;

FIG. 3B shows an example embodiment of an unfolded insert;

FIG. 4A shows an example of a first operative configuration with a first embodiment of the insert;

FIG. 4B shows an example of a second operative configuration with the first embodiment of the insert;

FIG. 5A shows an example of the first operative configuration with a second embodiment of the insert; and

FIG. 5B shows an example of the second operative configuration with the second embodiment of the insert.

### DETAILED DESCRIPTION

In the following description reference is made to the accompanying drawings in which are shown, by way of illustration, exemplary embodiments.

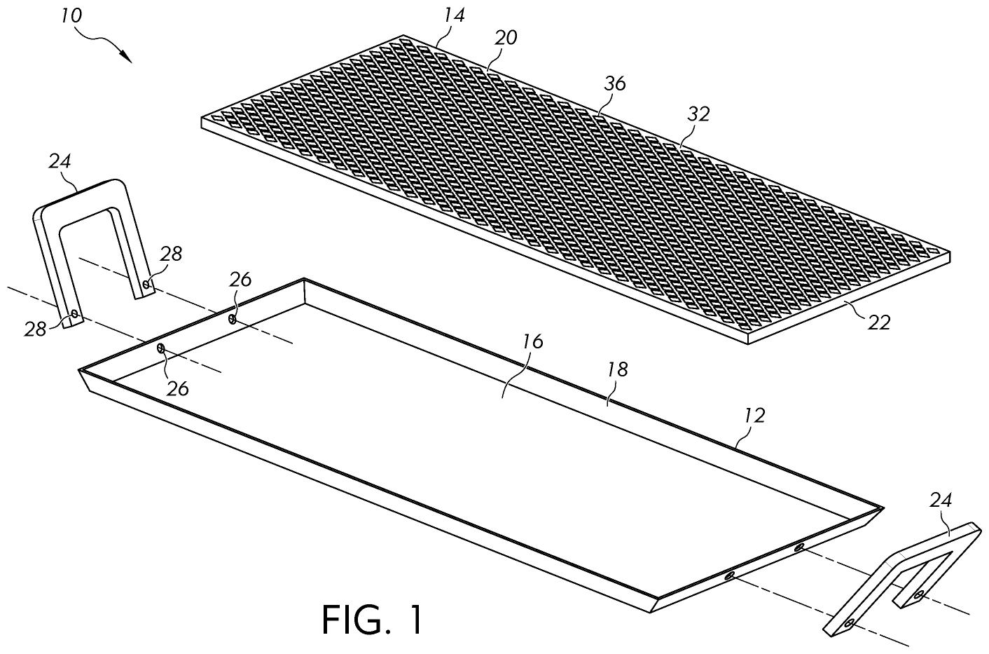

Turning to FIG. 1, an embodiment of a multi-function griddle pan assembly 10 includes a pan 12 and an insert 14 removably placed on the pan 12. The pan 12 can have a pan surface 16 and a pan sidewall 18 extending from and about a perimeter of the pan surface 16. The insert 14 can have a planar wall 20 and an insert sidewall 22 extending from and about a perimeter of the planar wall 20.

In an embodiment, the pan surface 16 is substantially planar, though it also could have other profiles to suit a variety of desired configurations; e.g. sloping or stepped.

The pan surface 16 can take any shape consistent with a desired use. For example, in the illustrated embodiment the pan surface 16 is rectangular. But it can be square, circular, or any other suitable shape. The shape of the pan surface 16 can be configured based on the size and shape of the stovetop or the size of the oven, for example.

The pan sidewall 18 can extend from the pan surface 16 at any angle consistent with the desired use. In one embodiment, the pan sidewall 18 extends perpendicularly from the pan surface 16. In another embodiment, the pan sidewall 18 extends from the pan surface 16 at an angle other than 90°. In the illustrated embodiment the sidewall 18 slopes outward from a center of the pan 12 as the wall 18 progresses away from the pan surface 16. This can be useful to retain drippings in the pan because drippings (such as condensation) that may fall to or form on the sidewall 18 will flow downward back into the pan toward the pan surface 16. The height of the pan sidewall 18 can be substantially uniform or have portions that vary in height.

The pan 12 can further have one or more handles 24 attached, e.g. to the sidewall 18. In the illustrated embodiment the pan 12 has two handles 24 attached to two opposing portions of the sidewall 18. Any number of pan handles 24 and locations of the pan handles 24 are contemplated.

In one embodiment, the handle 24 is a generally “U-shaped” and its legs are attached to the sidewall 18. The handle 24 can be attached via fasteners (e.g. screws) that pass through a hole 26 in the sidewall 18 and a corresponding hole 28 in a leg of the “U-shaped” handle 24. Alternatively, the pan sidewall 18 includes an outwardly extending protrusion and the “U-shaped” handle 24 includes a corresponding hole in a leg and a locking mechanism is placed on a portion of the protrusion extending from the handle 24 when it is attached. The handle 24 can be attached to the pan 12 by any suitable means.

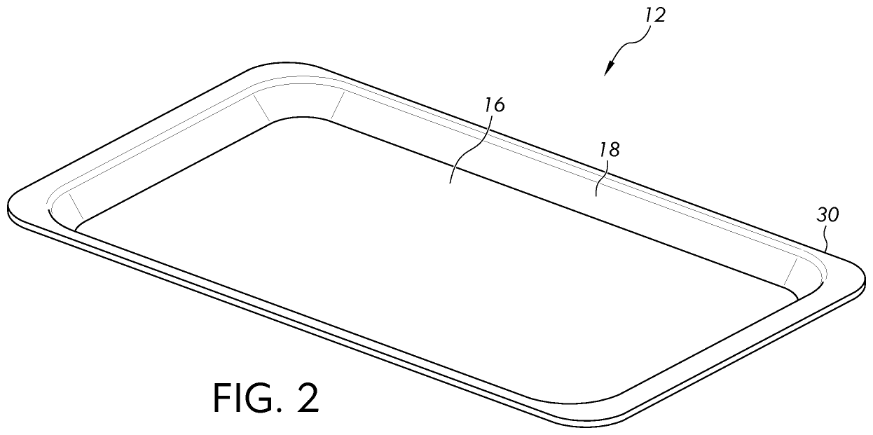

In an embodiment shown in FIG. 2, the pan 12 can include a perimeter flange 30 extending outwardly from a terminal edge of the pan sidewall 18. In one version, the flange 30 extends outwardly from an entire length of the terminal edge. Alternatively, the flange 30 can extend from only portions of the sidewall 18; e.g. individual flange segments extending from specific or spaced locations about the terminal edge of the sidewall 18.

Returning to the insert 14, its planar wall 20 has a top surface 32, a bottom surface 34, and a plurality of apertures 36 extending therethrough. Any shape consistent with the desired use for the apertures 36 is contemplated. For example, the apertures 36 can be circular, square, or any other shape. In the illustrated embodiment, the apertures 36 are diamond shaped.

Any number and/or arrangement of apertures 36 is contemplated. For example, in the illustrated embodiment an array of diamond-shaped apertures are formed in the planar wall 20 of the insert 14, e.g. via stamping, leaving behind a lattice structure forming the wall and defining the apertures. The lattice defines the plurality of apertures 36 arranged in parallel rows extending diagonally across the wall 20 of the insert 14. But other arrangements are contemplated. For example, the plurality of apertures 36 can be arranged in the form of concentric circular apertures, which can be formed by cutting, punching, or other appropriate technique. This may be desirable when the pan, and hence the insert 14 and its planar surface 20 are circular. Still further, arrays of other-shaped apertures (e.g. square, circular, other polygonal, or closed shapes), can be provided in definite arrays or arranged at random in the wall 20. Optionally, one or more such apertures 36 can be specially shaped to define a particular image, message or other indicia, which it is desired to convey to a user and, optionally, to transfer to grilled food.

Any shape of the planar wall 20 consistent with a desired use is contemplated. Ideally, the shape of the planar wall 20 of the insert 14 will be similar to the pan surface 16.

Similar as for the pan 12, the insert sidewall 22 can extend from the planar wall 20 of the insert 14 at any angle consistent with the desired use. In an embodiment, the insert side wall extends from the planar wall 20 perpendicularly. In another embodiment, the insert sidewall 22 extends from the planar wall 20 at an angle other than 90°. Optionally, the array of apertures 36 formed in the planar wall 20 of the insert can continue into the sidewall 22; as, for example, when the sidewall and adjacent planar wall 20 are formed together and separated by bending a previously-stamped (to form the apertures 36) sheet of metal. Alternatively, the sidewall 22 can be made separately and attached to the planar wall 20 to form the insert; in which case the sidewall 22 can include apertures similar to the apertures 36 in the wall 20, apertures different from the apertures 36 in the wall 20, and/or can be solid with no apertures.

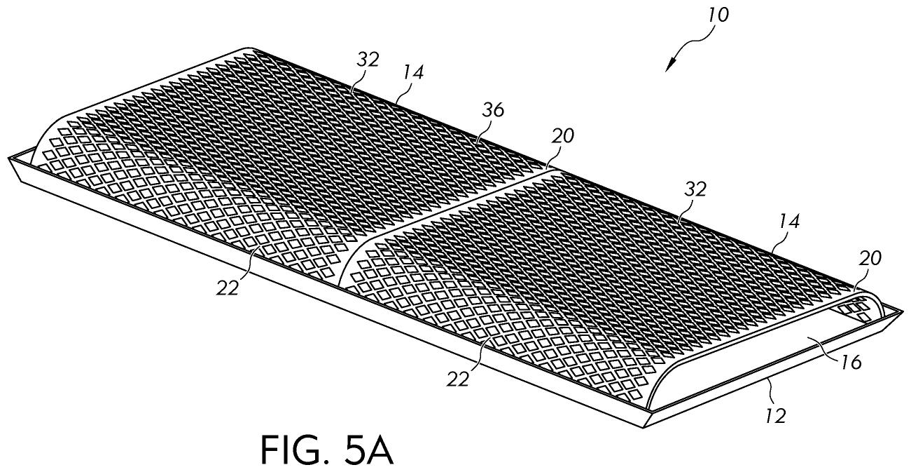

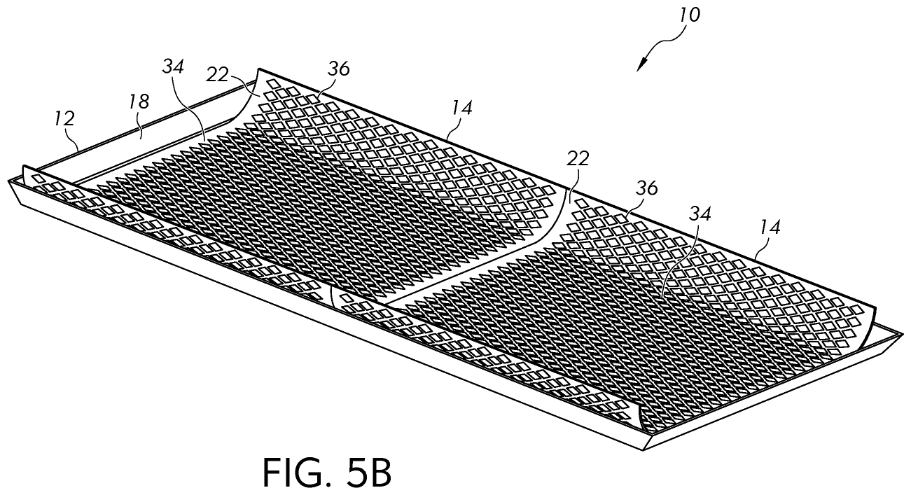

As noted above and seen in FIG. 1, the insert sidewall 22 can extend from and about the full perimeter of the planar wall 20. In an alternative embodiment, the insert 14 can include opposing sidewalls 22 extending from or adjacent to opposite peripheral edges or other locations along the perimeter of the planar wall 20, as seen in FIGS. 5A-5B. Alternatively, any number of insert sidewalls 22 is contemplated, which can be continuous and/or separated.

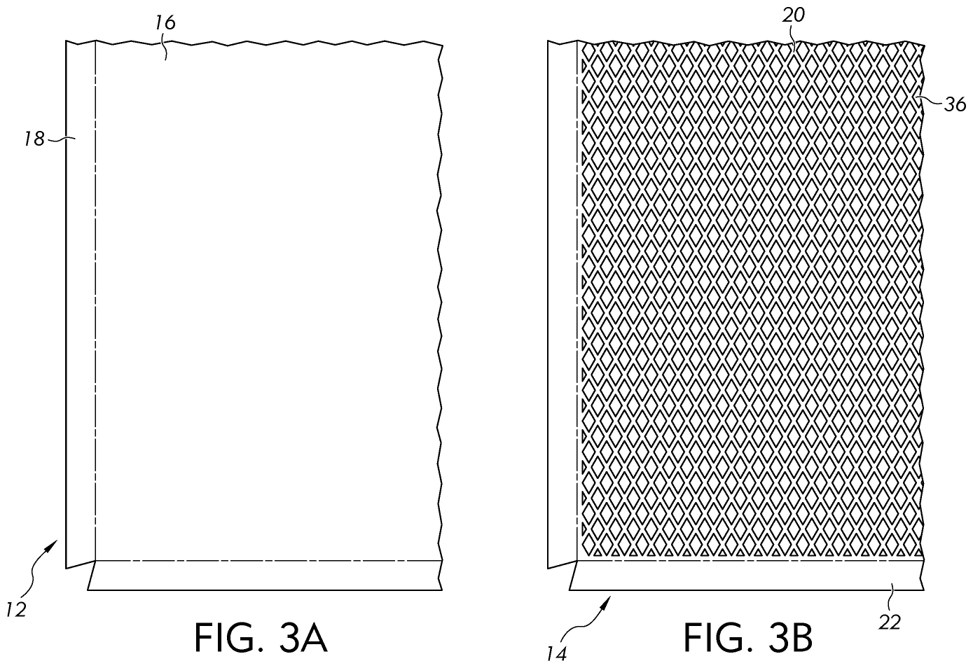

In another embodiment, the insert 14 includes a wire grid or other mesh that provides passages (e.g. apertures 36) through a planar wall thereof on which food may rest when cooking. Any method of manufacturing and/or suitable material may be used for the pan 12 and the insert 14 or for their components. In an embodiment, the pan sidewall 18 is formed as a separate frame to which the pan surface 16 is attached. In a further embodiment shown in FIG. 3A, the pan sidewall 18 is formed by bending edge portions of the pan upward to form edged stand-offs that define the pan sidewall 18. In a version of this embodiment, the intersecting edge portions of the pan 12 are trimmed at their lateral edges in order to meet at a seam. Further still, the pan with sidewall 18 can be formed by stamping or embossing. The insert 14 can be made in these or other similar ways, wherein apertures 36 can be formed by stamping, cutting, punching or other suitable techniques as discussed above. If formed of a wire grid or other mesh, such mesh can be secured to a perimeter sidewall 22 to form the completed insert 14.

The insert 14 and the pan 12 can be combined together in a plurality of configurations to support various different modes of cooking. These combinations create a variety cooking surfaces useful in different cooking modes that may be suited to different types of foods.

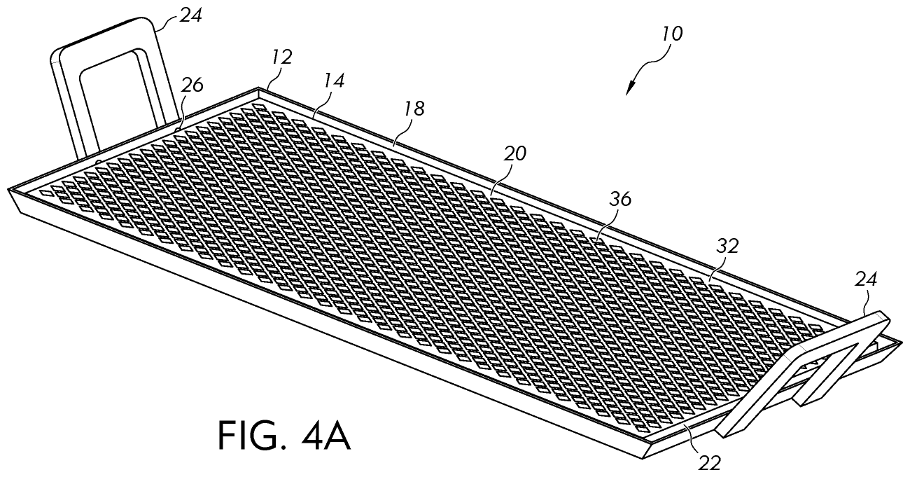

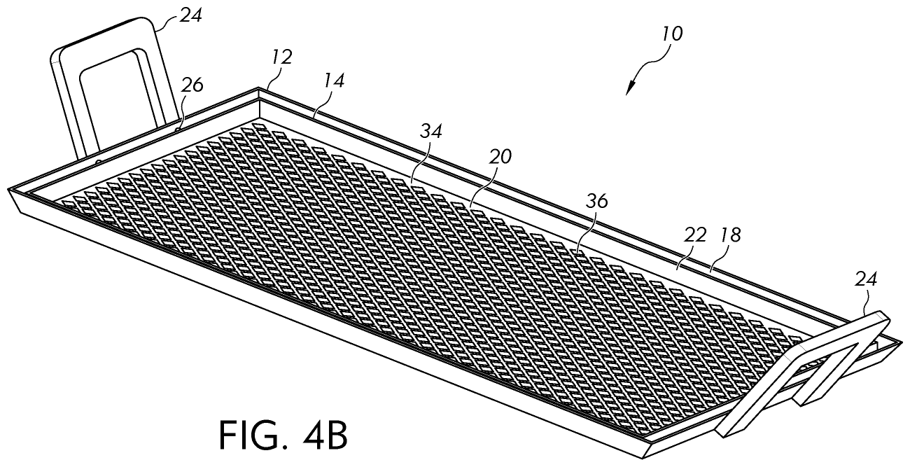

Turning to FIGS. 4A-4B and 5A-5B, illustrated are a first configuration (FIGS. 4A and 5A) and a second configuration (FIGS. 4B and 5B) of the pan 12 and the insert 14. The insert 14 illustrated in FIGS. 4A-4B includes an insert sidewall 22 that extends about the full perimeter of the planar wall 20, and which intersects the planar wall 20 at sharp bends. Comparatively, the insert 14 illustrated in FIGS. 5A-5B includes opposing sidewalls 22 extending from opposite peripheral edges of the planar wall 20, and which are formed via radiused bends from the planar wall 20.

In the first configuration, shown in FIGS. 4A and 5A, the insert 14 is placed into the pan 12 such that a terminal edge(s) of the insert sidewall 22 rests on the pan surface 16, wherein the planar wall 20 of the insert 14 is spaced above the pan surface 16 by the height of the insert sidewall 22. In this configuration the pan 12 and insert 14 are configured as a broiler, wherein food to be broiled can be supported and rests on the upper surface 32 of the planar wall 20 of the insert 14. The assembled broiler configuration (with food resting on the top surface 32) can be placed in an oven to broil the food as in a conventional broiler. In this ‘broiler’ configuration, drippings from the food resting (and cooking) on the top surface 32 of the insert 14 can drain into the underlying pan 12 through the apertures 36.

In the second configuration, shown in FIGS. 4B and 5B, the insert 14 is inverted such that its top surface 32 rests on and in contact with the pan surface 16 of the pan 12. In this configuration, the assembly is configured as a grill or charbroiler, wherein the apertured wall 20 (bottom surface 34) of the insert 14 acts as a grill or grate on which food may be grilled. The pan 12 (with the insert 14 therein) can be placed on a cooktop and cooktop heating elements (e.g. gas or electric burners) used to heat the pan 12, and also the insert 14, in order to grill or charbroil food resting thereon. Alternatively, this ‘grill’ configuration of pan 12 and insert 14 can be placed on a griddle to supply the cooking heat. This ‘grill’ configuration can be desirable when one wants to grill (or perhaps sear) food, such as after broiling in the oven if it is desired to add grill marks. To that end, the aperture configuration of the apertured wall 20 can depict or embody any pattern or indicia that it is desired to sear into food as ‘grill marks’ (a diamond pattern is shown).

Where only one insert 14 is received in the pan 12, the insert can be dimensioned to substantially correspond to the dimensions (eg. length×width) of the pan 12 (see FIGS. 4A and 4B). Alternatively, it also is possible to use multiple inserts in a single pan 12, in which case each insert must be dimensioned so that they can fit together within the pan 12 (see FIGS. 5A and 5B).

In a further alternative configuration, the insert 14 can be used alone, without the pan, to support food to be grilled over a heating source, e.g. on the top surface 32 of the insert 14. In this configuration the sidewalls 22 of the insert will face downward and rest on the cooktop surface so that the wall 20 straddles the heating source (e.g. burner) so that food can be placed thereon for cooking. This configuration may be desirable from the standpoint of allowing drippings to fall away from grilling food. But it can be undesirable insofar as those drippings then may fall to the cooktop and foul the cooktop surface or the burner(s).

In still a further configuration, the insert 14 can be positioned above a heat source on the cooktop as above, with the pan 12 resting upon the top surface 32. In this configuration the pan 12 acts as a frying pan, so that food may be placed therein for frying over the cooktop. In this ‘fryer’ configuration, the pan 12 may have depth sufficient to hold a quantity of frying fluid, such as oil, if desired, wherein the depth will be fixed based on the height of the sidewall 18 of the pan 12. In an alternative ‘fryer’ configuration, the insert 14 may be inverted so that its top surface 32 rests on the cooktop and its bottom surface 34 faces upward, wherein the pan can rest on the bottom surface 34 of the insert with the insert sidewall 22 facing upward. In this arrangement the pan 12 is essentially nested within the insert 14.

In addition, the insert 14 and the pan 12 can be used separately as independent cooking utensils presenting unique cooking surfaces. For example, the pan 12 can be placed on a cooktop by itself to act as a griddle. In another example, the insert 14 can be placed directly on the cooktop for open air cooking. In one version, the insert 14 is placed with the insert sidewall 22 facing downward to elevate the top surface above a cooktop surface (as in the ‘chargrill’ configuration described above). In another version, the insert 14 is placed with the insert sidewall 22 facing upward such that the top region 32 is in contact with a cooktop surface.

As can be seen, the disclosed assembly includes a pan 12 and an insert 14 that can be used together or independently to provide a variety of different configurations to support a variety of different cooking modes. The assembly can be configured as a broiler, fryer, charbroiler, grill, or griddle, among other possible cooking configurations. And when used on a cooktop the surface that supports food (e.g. either the wall 20 of the insert or the pan surface 16) can be placed in direct contact with the heating source (burner, surface griddle) to receive direct heat, or it may be spaced from the heating source via its own sidewall or by resting on the other of the pan 12/insert 14 to receive indirect or radiant heat, depending on the cook's preference. Thus, a versatile companion cooking utensil capable of a multitude of different configurations can be provided from only two elements: the pan 12 and the insert 14.

The invention has been described according to example embodiments. However, it will be understood by those skilled in the art that various alternatives and equivalents may be substituted for elements or steps described herein without deviating from the scope of the invention. Modifications may be made to adapt the invention to a particular situation or to a particular need without departing from the scope of the invention. It is intended that the invention not be limited to the particular embodiments described herein, but that the claims be given their broadest interpretation to cover all embodiments, literal or equivalent, covered thereby.

1. A multi-function griddle pan assembly comprising:
a pan comprising:
a pan surface, and
a pan sidewall extending from the pan surface; and
an insert removably positionable on the pan surface, the insert comprising:
a planar wall having a top surface, a bottom surface, and a plurality of apertures therein, and an insert sidewall extending from said top surface;
wherein in a first configuration said insert sidewall is configured and dimensioned to rest, and support said insert, on said pan surface inward of or bounded by said pan sidewall such that said planar wall of said insert is spaced above said pan surface a distance corresponding to a height of said insert sidewall; and
wherein in a second configuration said insert planar wall is configured and dimensioned such that its top surface rests, and supports said insert, on said pan surface inward of or bounded by said pan sidewall, such that said insert sidewall extends upward from said pan surface.

2. The assembly of claim 1, the pan sidewall extending from said pan surface at an angle greater than 90°.

3. The assembly of claim 1, the plurality of apertures comprising parallel rows of diamond shaped apertures in said insert planar wall.

4. The assembly of claim 1, said insert sidewall further comprising apertures extending there-through.

5. The assembly of claim 1, the insert sidewall being formed by trimming a portion of a lateral edge at each corner of the planar surface and bending at least two edge portions of the planar surface adjacent the trimmed portion to meet at a seam.

6. The assembly of claim 1, the insert being formed by bending a sheet of metal that has been previously punched or cut to provide said apertures therein, to thereby provide said insert having a substantially U-shaped cross-section with two opposing side walls extending from said planar surface thereof.

7. The assembly of claim 1, the pan further comprising a handle attached to the pan sidewall.

8. The assembly of claim 1, the pan further comprising a flange extending outwardly from a terminal edge of the pan sidewall.

9. The assembly of claim 1, the insert further comprising at least one handle attached to the insert sidewall.

10. A method of cooking utilizing a griddle-pan assembly that comprises a pan having a pan surface and a pan sidewall wall extending from said pan surface, and an insert having an apertured planar wall and an insert sidewall extending from a top surface of said planar wall, the method comprising:
configuring said griddle-pan assembly in a broiler configuration by positioning said insert within said pan such that a perimeter edge of said insert sidewall rests on said pan surface, wherein said planar wall of said insert is spaced above said pan surface a distance corresponding to a length of said sidewall; and
configuring said griddle-pan assembly in a charbroiler configuration by inverting said insert such that said top surface of the apertured planar wall thereof rests on said pan surface, wherein said insert sidewall extend upward away from said pan surface.

11. The method of claim 10, comprising broiling food resting on said top surface of said planar wall of said insert within an oven cavity of a cooking range in said broiler configuration, and charbroiling food resting on a bottom surface of said planar wall of said insert on a cooktop of said cooking range in said charbroiler configuration.

12. The assembly of claim 1, wherein the top surface of said insert planar wall is resting on said pan surface.
